(19) United States
(12) Patent Application Publication
(10) Pub. No.: US 2003/0142968 A1
(43) Pub. Date: Jul. 31, 2003

(54) Die cast heating element for heating liquids and method of making same

(76) Inventor: Dov Z. Glucksman, Wenham, MA (US)

Correspondence Address: KENYON & KENYON, ONE BROADWAY, NEW YORK, NY, 10004, US

(21) Appl. No.: 10/229,828

(22) Filed: Aug. 28, 2002

Related U.S. Application Data
(63) Continuation of application No. 09/801,529, filed on Mar. 8, 2001, now abandoned.
Application No. 09/801,529 is a continuation of application No. 09/558,605, filed on Apr. 26, 2000, now abandoned.
Application No. 09/558,605 is a continuation of application No. 08/668,038, filed on Jun. 7, 1995, now abandoned.
Application No. 08/668,038 is a continuation of application No. 08/296,400, filed on Aug. 26, 1994, now abandoned.

(51) Int. Cl. H05B 3/48

(52) U.S. Cl. 392/503; 219/548

(57) ABSTRACT

A heating element for heating liquids, comprising a heating coil coiled about a central axis. The coil has a first end and a second end lying in a plane substantially parallel to the central axis. The coil is covered with insulation which is covered with a protective sheath. The protective sheath is covered with an aluminum housing provided with a central aperture to increase the surface area of the heating element in contact with the liquid to improve start-up time. The aluminum housing is also provided with an aperture to receive a thermostat. A pressure die having a first portion and a second portion is adapted to receive a spacer between the first and second portions to vary the distance between the first and second portion and allow for the manufacture of heating elements of varying diameters.

### FIELD OF THE INVENTION

This invention relates generally to heating elements, and more particularly to die cast heating elements for heating liquids. The invention further relates to a method of making such die cast heating elements.

### BACKGROUND OF THE INVENTION

Heating of liquids in a container, such as a humidifier, is usually accomplished in one of two conventional ways: either by transferring heat from the outside of the container through the walls of the container or by immersing a heater in a container that contains the liquid to be heated. Immersing a heater in the liquid has many advantages. One advantage is that it allows the liquid to be contained in a container which is made of material having a melting point lower than the temperature reached by the heating element, e.g., some plastics. Another advantage is that by immersing the heater in the liquid little heat is wasted because substantially all of the heat generated by the heater is absorbed by the liquid.

Another advantage of immersion heaters is that they facilitate cleaning of both the heating element and reservoir. This is especially true if the water to be heated is rich in minerals because the minerals, primarily calcium salts, are deposited and accumulate on the outer surface of the heater. These accumulations reduce operating efficiency because they act as an insulator. After the water has boiled off and the heater operates for a short period of time in air, the minerals can be easily flaked off the heater by gently rubbing the heater. A removable immersion heater also allows easier access to the reservoir and facilitates collection and removal of the flakes from the reservoir.

Conventional immersion heaters often comprise a sheathed heating element which is provided with a resistance heater in its core. The heater is often surrounded by an electrical insulating powder made of a metallic salt, e.g., Mg₂O₃, which is contained in a high temperature metallic sheath that prevents the liquid from touching the electric components of the heater. The outer sheath is often made of materials such as stainless steel, copper, or regular steel. There are, however, several disadvantages associated with the use of these conventional sheathed elements when they are immersed in water.

One disadvantage is that the sheath tends to be attacked by the water and corrodes as a result of the minerals which are suspended in the water and deposited on the sheath. Another disadvantage is that it is difficult to sense the overheating of the heater when water is depleted unless a thermostat is physically attached to the heating element. External thermostats are exposed and vulnerable to damage. Also, because the heating element is submerged in water, the thermostat must be placed in an enclosure that is water tight. Another disadvantage of this structure is that calcium or other debris may lodge between the thermostat enclosure and the heating element, thus forming an insulating layer which could interfere with the thermostat's rapid and accurate sensing of the temperature which could cause heater burnout and/or a fire. The thermostat enclosure must be thermally conductive and be able to withstand high temperatures. It must also be conductively attached to the immersion water heater so that the thermostat senses the temperature of the heating element.

In order to overcome these disadvantages, as will be discussed further a new heater is proposed which is based on using a specifically designed sheathed heating element and encapsulating it in a die cast aluminum casing. To encapsulate it in aluminum, the heater is placed in a pressure die and molten aluminum is introduced into the die and it coats the heater and conforms to the shape of the die. The aluminum casing is provided with an aperture to house a thermostat. This provides a safe and secure place for a thermostat and allows for accurate readings.

### SUMMARY AND OBJECTS OF THE INVENTION

It is object of this invention to provide an immersion water heater which is resistant to corrosion and results in more efficient transfer of heat and, thus, prolonging heater life.

It is another object of this invention to provide an immersion water heater comprising a heating coil lying in a first plane; the heating coil having a first end and a second end, the first end and the second end lying in a second plane substantially perpendicular to the first plane, an insulator sheathing the heating coil; a protective coating sheathing the insulator; and an aluminum housing sheathing the protective coating, the housing provided with an aperture for receiving a temperature sensor.

It is another object of the present invention to provide an adjustable die for manufacturing heating elements having a plurality of loops.

It is another object of this invention to provide an immersion water heater which can be immersed in a smaller volume of water than is required for conventional heaters so as to shorten heating time.

It is another object of this invention to provide an immersion water heater with a reduced height so as to reduce the overall size of the appliance utilizing said heater.

It is another object of the present invention to provide a method of making a heater.

It is another object of the present invention to provide a heating element, comprising: a heating coil having a first end and a second end, with the coil coiled about a central axis and the first end and the second end lying in a plane substantially parallel to the axis; an insulating coating surrounding the heating coil; a protective sheath surrounding the insulating coating; an aluminum housing surrounding the protective sheath, the aluminum housing provided with a central aperture.

### BRIEF DESCRIPTION OF THE DRAWINGS

FIG. 1 shows a conventional die cast heater comprising a coiled heating element encapsulated in a die cast aluminum casing;

FIG. 2 shows the coiled heating element of FIG. 1;

FIG. 3 is a cross-sectional side view along line 3-3 of the heater of FIG. 1;

FIG. 3A shows the die cast heater of FIG. 1 mounted on a bottom of a liquid heating container;

FIG. 4 shows a an immersion water heater made in accordance with the invention;

FIG. 5 shows the coiled heating element of the immersion water heater shown in FIG. 4;

FIG. 6 is a bottom view of the immersion water heater shown in FIG. 4;

FIG. 7 is a cross-sectional side view taken along lines 7-7 of FIG. 6;

FIG. 8 is a top view of the immersion water heater shown in FIG. 4;

FIG. 9 is a cross-sectional side view of a heater shown in FIG. 4 disposed in the bottom of a liquid heating container;

FIG. 10 is a cross-sectional side view of a three-loop embodiment of an immersion water heater made in accordance with the invention;

FIG. 11 is a cross-sectional side view of a conventional pressure die used to manufacture conventional immersion water heaters;

FIG. 12 is a cross-sectional view of the heater shown in FIG. 1 with a conventional two-loop heating element;

FIG. 12A is a cross-sectional view of a conventional heater with a three-loop heating element;

FIG. 13 is a cross-sectional side view of a die made in accordance with this invention;

FIG. 13A shows an alternative embodiment of the die of FIG. 13 which is adjustable to accommodate heating elements with a varied number of loops;

FIG. 14 is a cross-sectional side view of the die of FIG. 13 with a two-looped heating element in place after introduction of the molten aluminum; and

FIG. 15 shows a six-looped heating element in place in the die of FIG. 13A after introduction of the molten aluminum.

### DETAILED DESCRIPTION OF THE INVENTION

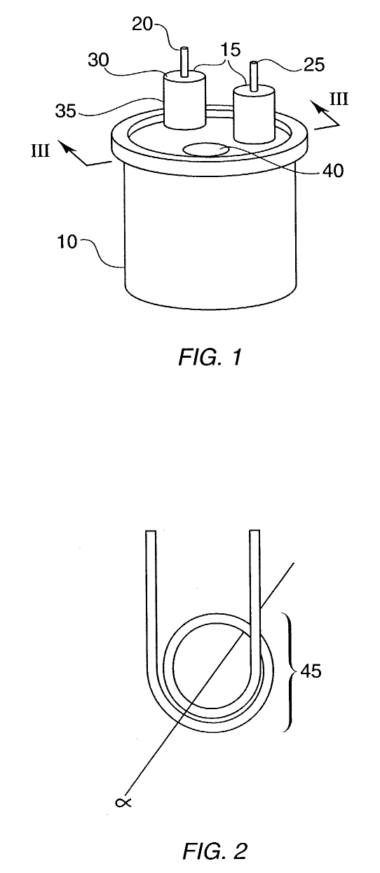

FIG. 1 shows a conventional immersion heater 5 and includes a casing 10, heating element 15 having a heating element first end 20, heating element second end 25, insulator 30, sheath 35, and thermostat recess 40. As shown in FIGS. 1, 2, and 3, the typical structure of conventional heater 5 comprises a sheathed heating element 15 which is coiled in a tight loop 45 coiled around axis ∝ encapsulated in a die cast casing 10 with the heating element first end 20 and second end 25 extending from the casing 10 at an angle substantially perpendicular to the axis ∝. The aluminum casing 10 surrounding and encapsulating the sheathed heating element 15 is shaped in a cylindrical form with its longitudinal axis substantially parallel to first end 20 and second end 25 and substantially perpendicular to axis ∝. The diameter, of the casing 10 is slightly larger than the outer diameter of the coiled loop 45 to accommodate the coiled loop 45 and provide a sufficient volume for both the loop and the molten aluminum which forms the casing 10. The height of the casing 10 is also slightly greater than the outer diameter of the coiled loop 45 in order to assure that the metal sheath 35 is entirely encapsulated in the aluminum casing 10.

The coiled loop 45 is produced by taking a straight section of a sheathed heating element and forming, or coiling, it around a steel mandril that has the outer diameter equal to the inner diameter of the loop, similar to the way that helical springs are conventionally made. This process is well known to those skilled in the art. A heater with two or more parallel loops can also be produced in the same manner.

After the heating element is coiled, it is placed into a die or mold into which molten aluminum is injected. The molten aluminum fills the cavity of the die and thus encapsulates or encases the sheathed heater except for its two ends which extend beyond the die structure so that electrical leads from a power source can be attached to energize the heating element.

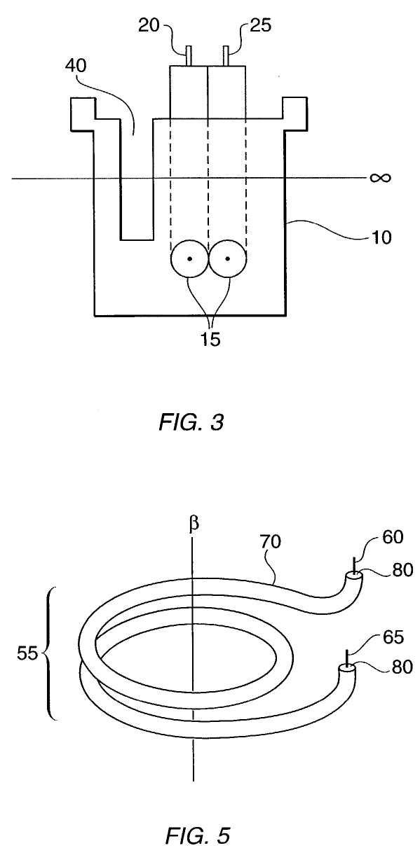

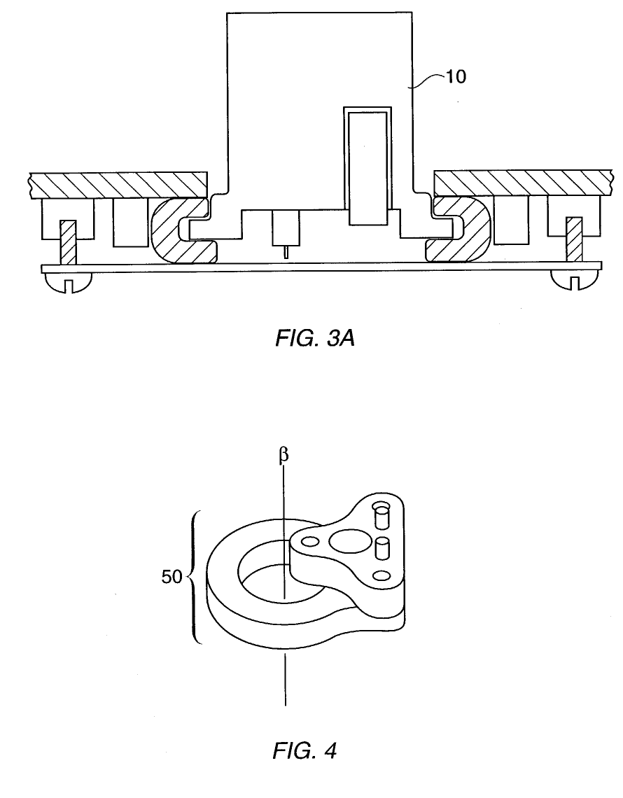

A recess 40 may be provided in the aluminum casing to receive a temperature sensing element, such as a thermostat, to deenergize the heating element in case it overheats, e.g., when all the water surrounding the heating element is depleted. FIG. 3A shows how a conventional immersion water heater may be mounted on a base of a water heating reservoir.

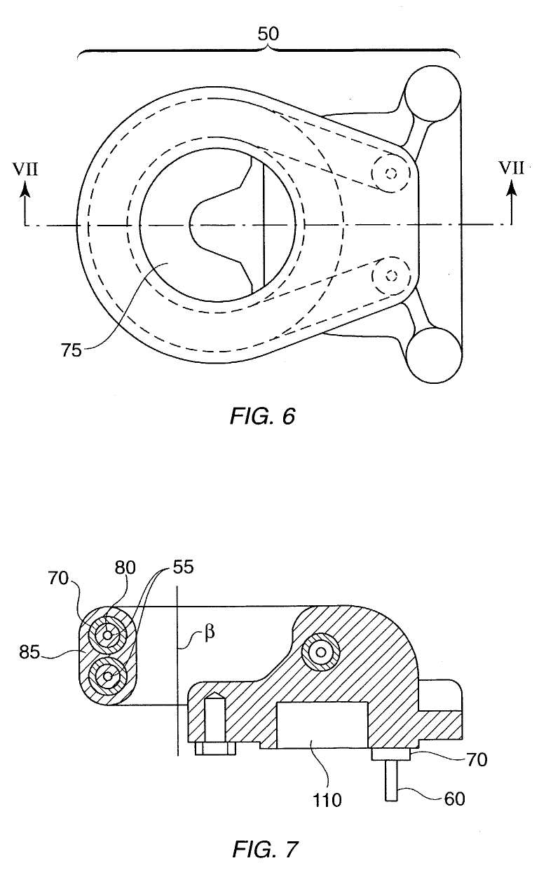

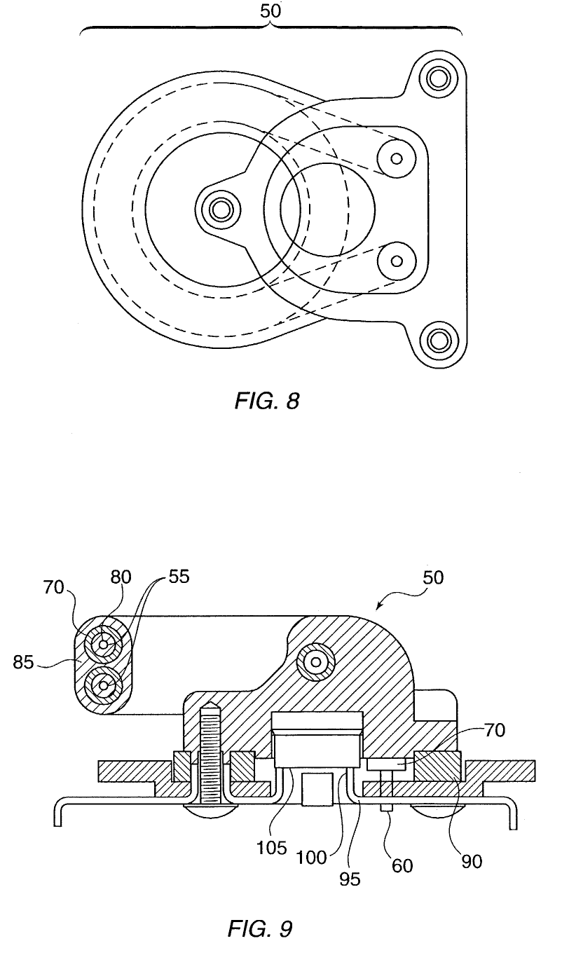

FIG. 4 shows an immersion water heater 50 constructed in accordance with the invention. FIG. 5 shows the tightly looped heating coil 55 encased in the immersion water heater 50 of FIG. 4 and shows a heating element first end 60, a heating element second end 65, insulation 80, and a heating element.protective sheath 70. FIG. 6 is a top view of the heater 50 of FIG. 4 and shows fluid aperture 75. Fluid aperture 75 provides a significant improvement over the prior art by increasing the surface area of the heater 50 in contact with the water which results in more rapid and more efficient heating of the water. FIG. 7 is a cross-sectional side view of the heater 50 shown in FIGS. 4 and 6 and shows heating coil 55, insulation 80, heating element protective sheath 70, aluminum housing 85, thermostat recess 90, and heating element first end 60.

A significant improvement over the prior art is achieved by Applicant's invention because of the unique orientation of the heating coil 55 to its aluminum housing 85 and the orientation of the heating coil first end 60 and second end 65 to the axis β around which the heating coil 55 is coiled. The axis β around which the heating coil 55 permits the die cast aluminum to form a toroidal shaped structure 85 which offers many cost, safety, and performance advantages. The aluminum housing 85 surrounding and encapsulating the sheathed heating coil 55 has its longitudinal axis substantially perpendicular to axis β and substantially perpendicular to heating element first end 60 and second end 65. As shown in FIGS. 5 and 7, the heating coil 55 is coiled in a tight loop about axis β with the heating element first end 60 and second end 65 bent at an angle substantially parallel to the axis of β around which the heating element 55 is coiled.

Heaters manufactured in accordance with Applicant's invention provide several significant improvements over the prior art. First, a minimal amount of aluminum is required to cover the heating element which results in cheaper production costs and the saving of natural resources. Since the heater shape closely follows the shape of the sheathed coil, only a thin skin of aluminum is required to protect the steel sheath from corrosion. In addition, the fluid aperture increases the surface area of the heater in contact with the water, thus, increasing heating efficiency.

FIG. 9 illustrates one way in which the heater 50 may be mounted on a housing of a plastic container. A flexible silicone, rubber gasket 90 serves as a seal to prevent water from seeping out of the container. The gasket 90, which withstands high temperature, also protects the plastic from contact with the high temperature heater 50.

An optional metal back-up plate 95 may be employed to provide extra safety. The metal plate 95 is provided with a collar portion 100 which provides the pressure to urge the thermostat 105 against the base of the thermostat recess 110 (shown in FIG. 7) for better heat transfer from the heater 50 to the thermostat 105.

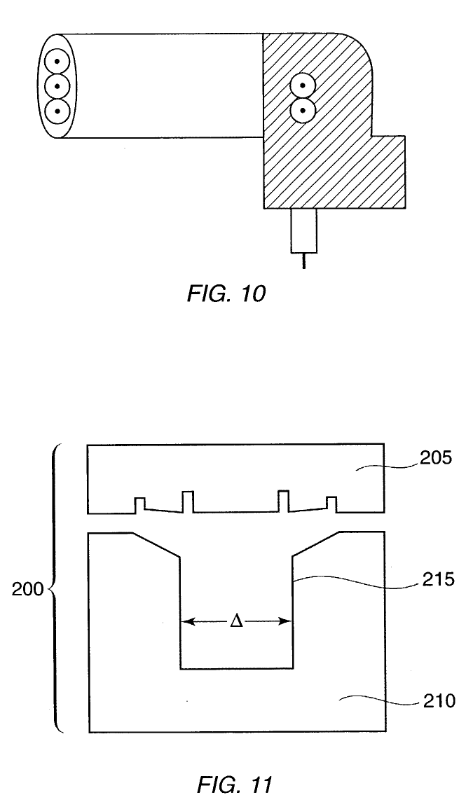

FIG. 10 shows an alternative embodiment of an immersion heater made in accordance with the invention which utilizes multiple loops to increase the heat transfer surface area in contact with the water while at the same time utilizing a minimum amount of aluminum.

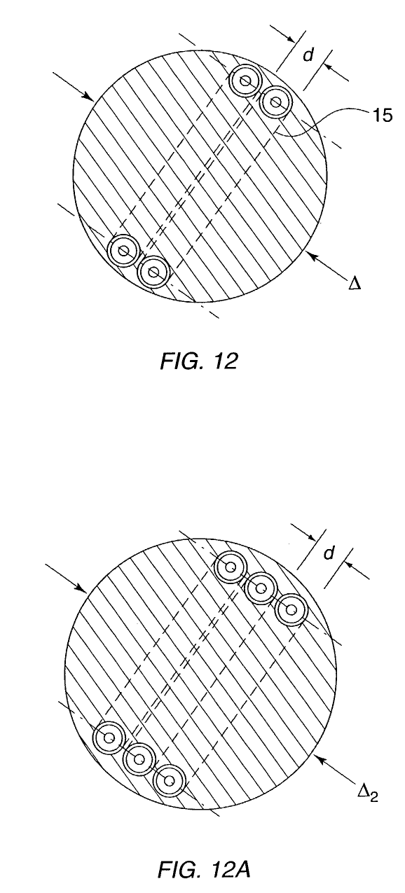

FIG. 11 is a cross sectional side view of a conventional pressure die 200, having a first portion 205 and a second portion 210. Second portion 210 is provided with a recess 215 having a diameter Δ. FIG. 12 shows a conventional two-looped sheathed heating element 15 having a diameter d sheathed in a die cast enclosure of diameter Δ. FIG. 12A shows a three-looped conventional sheathed heating element having a diameter d sheathed in a die cast enclosure of diameter Δ₂. Δ₂ is greater than Δ because of the extra coil. Because normally a die cast heater with a three-looped coil has a greater diameter than that with a two-looped coil, a second die must be prepared because the diameter Δ of a die 200 designed to produce a heater with two-looped coils cannot accommodate the greater diameter Δ2 required for a heater of the three-looped coil.

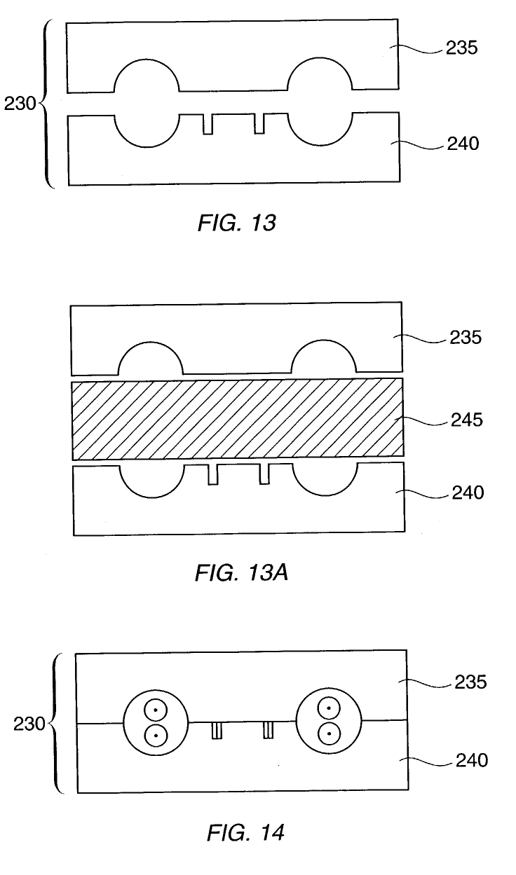

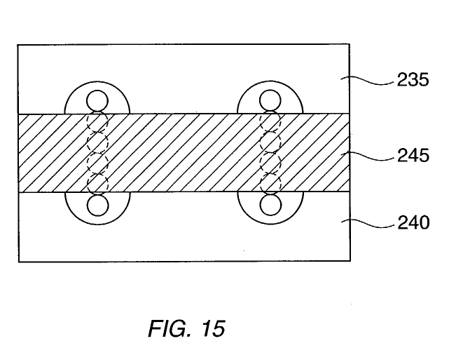

FIG. 13 shows a die 230 having a first portion 235 and a second portion 240 constructed in accordance with the invention. A spacer 245 may be inserted between first portion 235 and second portion 240 as shown in FIG. 13A. The size of spacer portion 245 may be varied as dictated by specific applications so that the die 230 can accommodate heating coils having multiple loops. This results in significant savings because the spacer 245 is relatively inexpensive when compared to the cost of a die. FIG. 14 shows a double looped heating coil disposed between top portion 235 and bottom portion 240 of die 230. FIG. 15 shows a six-looped heating element inserted into the die 230 with a spacer 245 disposed between first portion 235 and second portion 240. As shown, the same die can be utilized to produce heating coils with a varying number of loops by simply changing the size of the spacer 245 disposed between first portion 235 and second portion 240. Thus, by adding an extra spacer to the die casting mold the height of the cavity can be increased by the thickness of the added plate resulting in an aluminum structure that is higher and which would accommodate an extra loop of a heating element. This results in significant savings because a manufacturer need not purchase many dies to accommodate a variety of loop sizes.

This flexibility in manufacturing is very important because when designing heaters of different ratings for different applications one or more loops are often required. Thus, without having to build a new die with a different diameter and without having to modify the mounting structure in the appliance, heating elements with varying heights and a different number of heater loops can be more readily accommodated.

I claim:

1.) A heating element, comprising:
(a) A heating coil having a first end and a second end, said coil coiled about a central axis, said first end and said second end lying in a plane substantially parallel to said axis;
(b) an insulating coating surrounding said heating coil;
(c) a protective sheath surrounding said insulating coating; and
(d) an aluminum housing, surrounding said protective sheath, said aluminum housing provided with a central aperture.

2.) The heating element of claim 1, wherein said aluminum housing is adapted to receive a temperature sensor.

3.) The heating element of claim 2 wherein said temperature sensor is a thermostat.
